(19) United States
(12) Patent Application Publication
(10) Pub. No.: US 2005/0125974 A1
(43) Pub. Date: Jun. 16, 2005

(54) Burial casket

(76) Inventor: Leland D. Ozbun, Lynn, IN (US)

Correspondence Address: REED SMITH LLP, P.O. BOX 488, PITTSBURGH, PA, 15230-0488, US

(21) Appl. No.: 10/966,821

(22) Filed: Oct. 15, 2004

Related U.S. Application Data
(60) Provisional application No. 60/512,272, filed on Oct. 17, 2003.
(60) Provisional application No. 60/516,071, filed on Oct. 31, 2003.

(51) Int. Cl. A61G 17/00

(52) U.S. Cl. 27/19

(57) ABSTRACT

A particle board or corrugated casket is covered with cloth and trimmed with veneer. Specifically, the base portion of the lower shell of the casket and the rim portion of the cap of the casket are covered with veneer preferably having an ornamental molding. The remaining portions of lower shell and cap are covered with a decorative fabric, leather or cloth. In another embodiment, a domed casket is covered with a non-wood veneer.

This application claims the benefit under 35 USC 119(e) of U.S. Provisional Application Ser. No. 60/512,272 filed Oct. 17, 2003 and U.S. Provisional Application Ser. No. 60/516,071 filed Oct. 31, 2003.

### BACKGROUND OF THE INVENTION

1. Field of the Invention

The present invention relates to caskets, and more particularly to a casket having a veneer and cloth covering and to a domed casket having a non-wood veneer covering.

2. Description of the Related Art

Traditionally, caskets have been used for burial of the dead, both for in-ground burial and above-ground interment. Caskets are typically formed from expensive hardwood or from highly polished metal. Caskets may also be used for cremation. Traditionally, crematory caskets have been fabricated of less expensive corrugated cardboard or plywood. Typically a domed casket is covered with a wood veneer or they are made of solid wood or metal. Non-wood veneers have traditionally only been used on flat topped profile caskets due to the complexity of domed caskets.

In order to provide an economical choice for consumers, wood and metal caskets have been stripped down to bare minimum standards. However, the resulting caskets may not be aesthetically pleasing.

### SUMMARY OF THE INVENTION

According to at least one embodiment of the present invention, a particle board casket is covered with cloth and trimmed with a veneer. Veneers can be fabricated from natural or man-made materials such as wood, metals, paper, plastics or composites resembling metal, wood, paper, stone and other looks. Specifically, the base portion of the lower shell of the casket and the rim portion of the cap of the casket are covered with veneer preferably having an ornamental molding. The remaining portions of the lower shell and cap are covered with a decorative fabric or cloth, or leather.

In an alternative embodiment, a domed topped particle board casket is covered with a non-wood veneer made from man-made materials such as those discussed above.

The decorative non-wood veneer or cloth and veneer coverings provide an affordable yet attractive alternative to the more expensive hard wood and metal caskets.

These and other features and characteristics of the present invention, as well as the methods of operation and functions of the related elements of structure and the combination of parts and economies of manufacture, will become more apparent upon consideration of the following description with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

FIG. 1 shows a perspective view of a casket according to an embodiment of the present invention;

FIGS. 2-6 show examples of cloth and veneer combinations;

FIGS. 7-11 show perspective views of caskets having different examples of cloth and veneer combinations;

FIG. 12 shows a perspective view of an alternative embodiment of the present invention wherein a domed casket is covered in a non-wood veneer having the appearance of oak;

FIG. 13 shows a perspective view of a high-domed casket having a non-wood veneer covering having the appearance of cherry wood; and

FIG. 14 shows a perspective view of a low-domed casket having a non-wood veneer covering having the appearance of cherry wood.

### DETAILED DESCRIPTION OF THE INVENTION

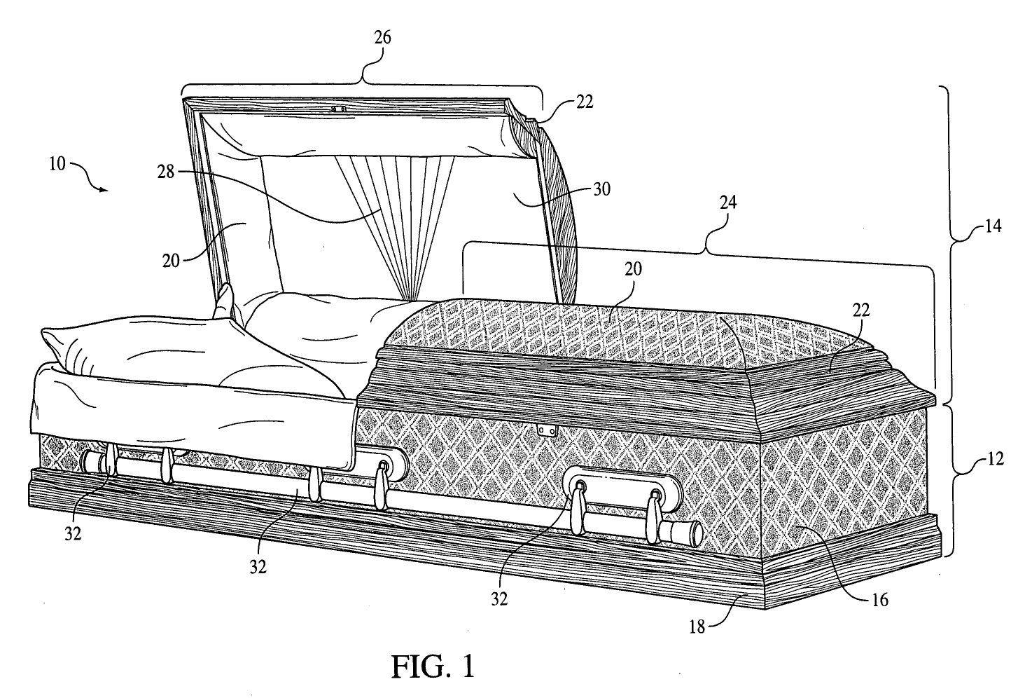

In one embodiment of the present invention illustrated in FIG. 1, the casket 10 includes a lower shell 12 and an upper cap 14 closeable on the lower shell. The lower shell 12 includes a body portion 16 and a base portion 18 surrounding the lower part of the body portion 16. The cap 14, which can be rounded or flat, includes a lid portion 20 and a rim portion 22 surrounding the lower part of the lid portion 20. The full length cap 14 can also be divided into a foot portion 24 and a head portion 26 which are each separately hinged to the lower shell 12.

The lower shell 12 and cap 14 are preferably formed from particle board, cardboard or other lightweight wood product such as wood products made from wood dust or wood chips.

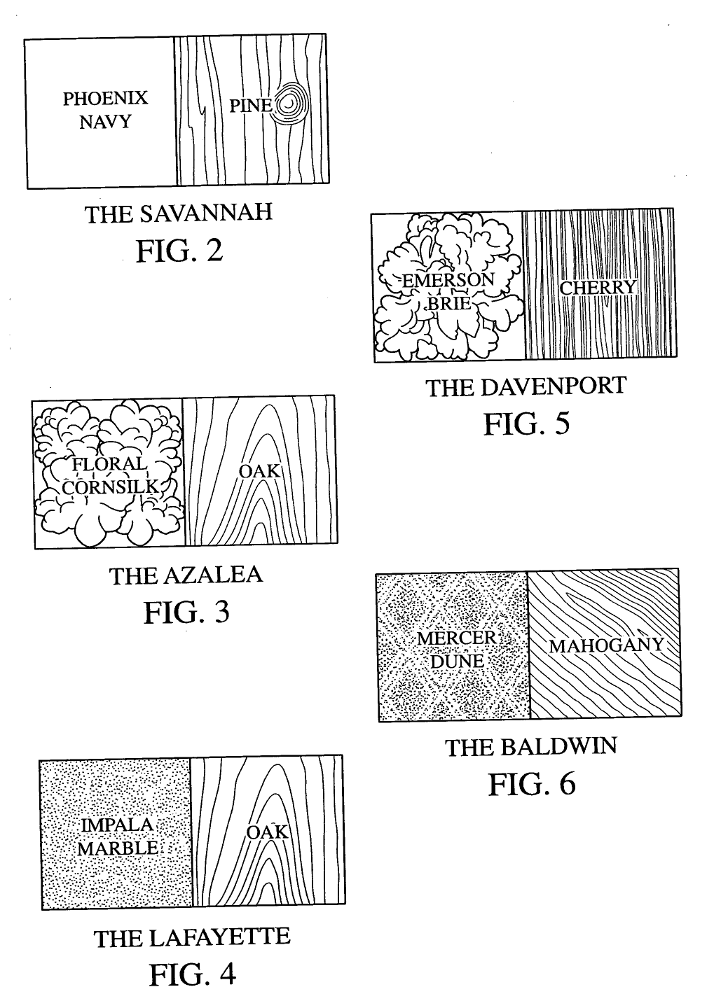

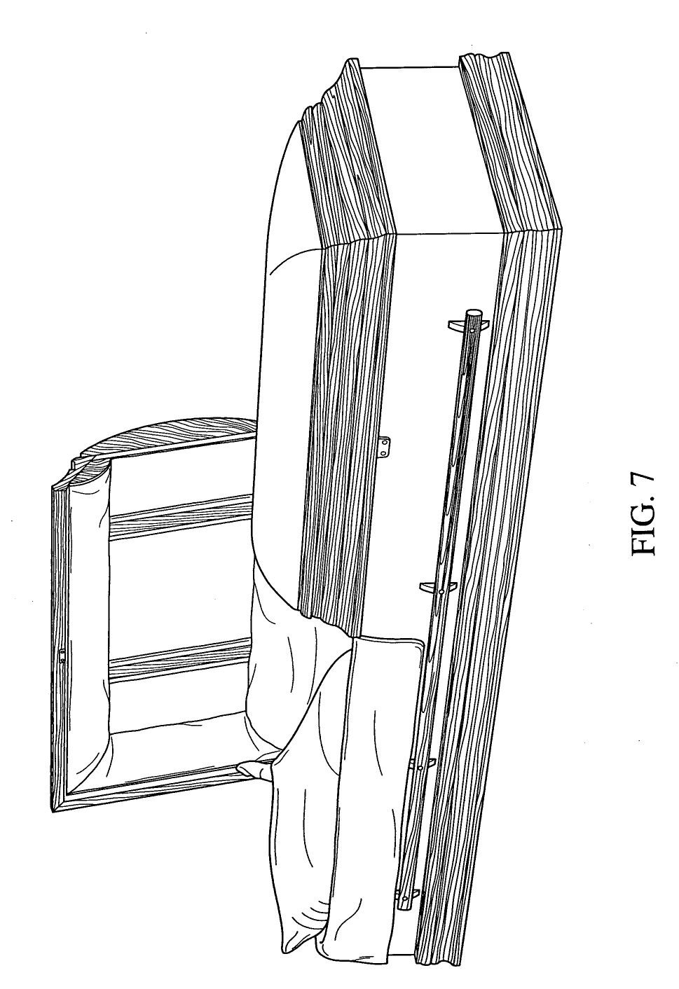

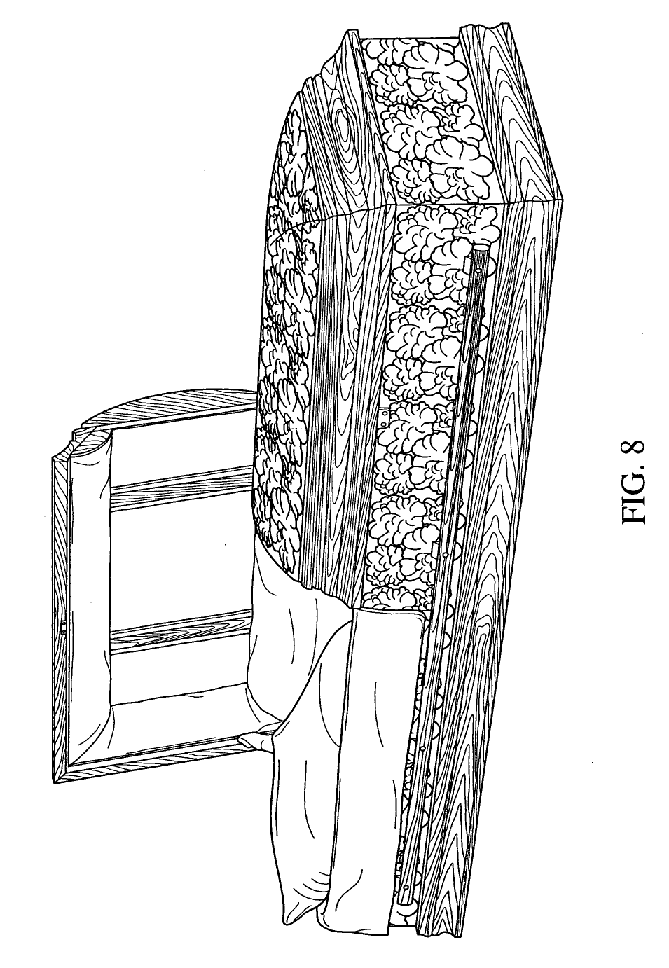

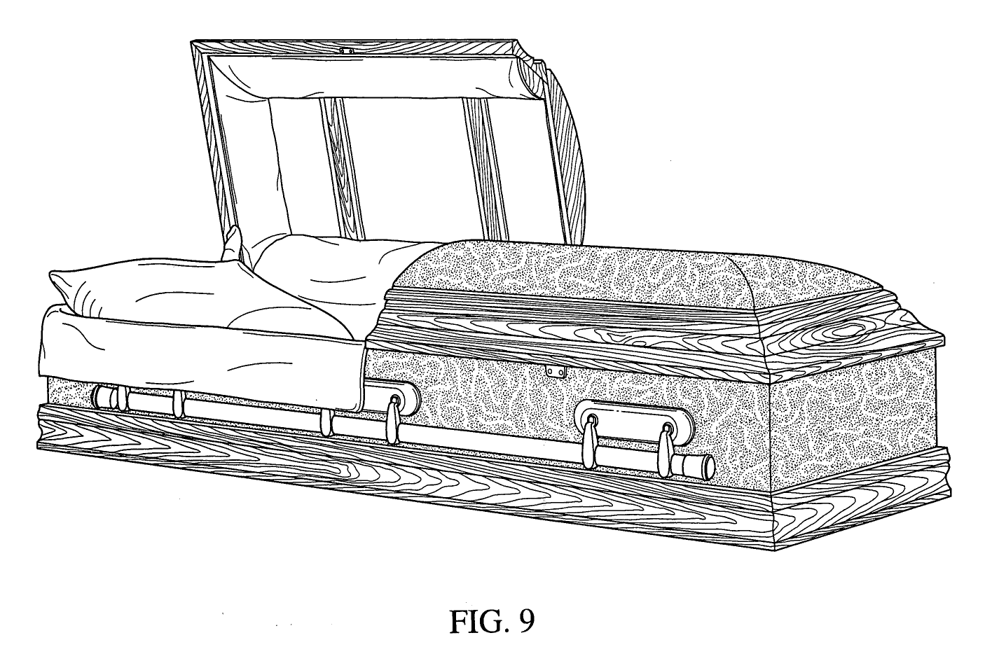

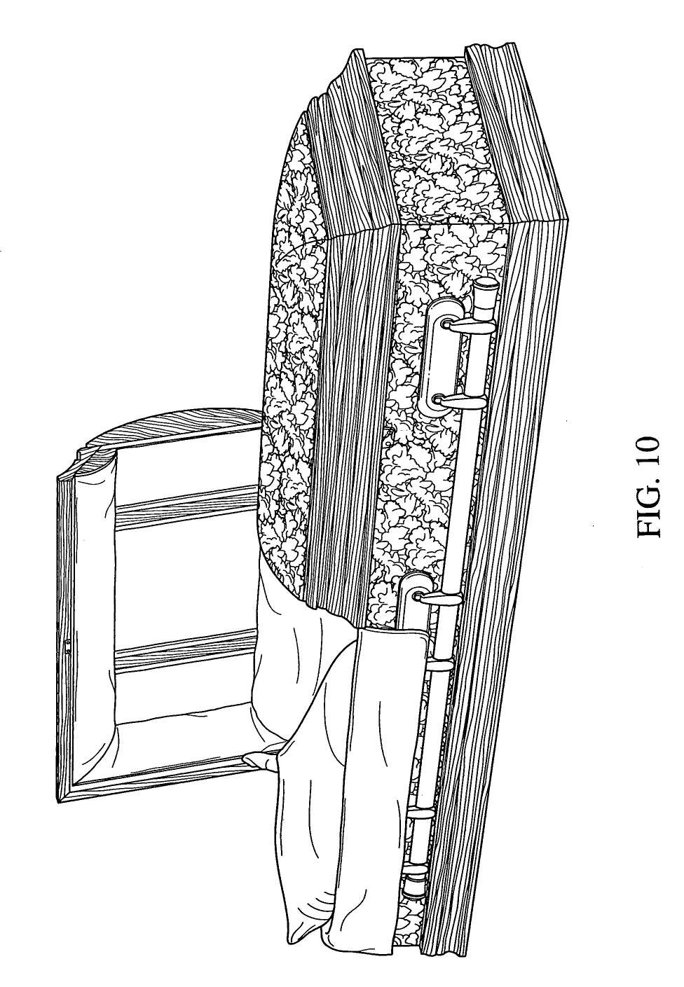

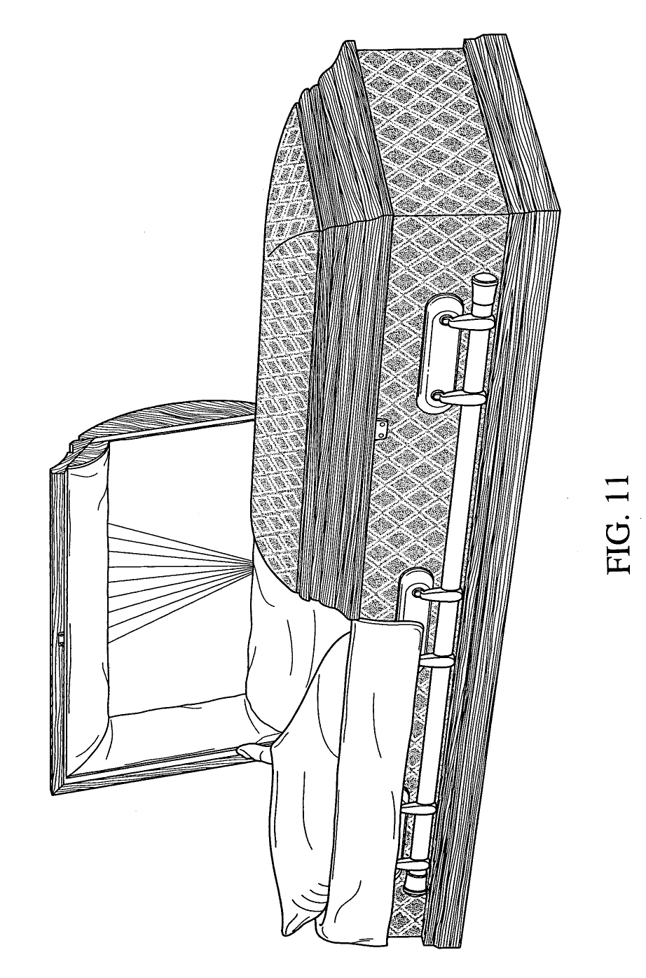

The base portion 18 of lower shell 12 and the rim portion 22 of the cap 14 are covered with a veneer preferably having an ornamental molding. Examples of suitable veneers include cherry, oak, pine and mahogany or any other suitable wood veneers as well as painted metals, nonpainted metals such as bronze, stainless, copper and stone tones such as marble, granite, sandstone and other logical variations of all the above. The body portion 16 of the lower shell 12 and the lid portion 20 of the cap 14 are covered with a decorative fabric, leather or cloth such as suede, tapestry, marbled, floral or other decorative or solid color fabrics. The consumer may select a desired veneer and cloth combination (FIGS. 2-11.)

The interior 28 of the cap 14 and lower shell 12 of the casket 10 are preferably lined in fabric 30, such as the same fabric covering as the body portion 16 of the lower shell 12, crepe, linen or velvet, or any combination thereof, which covering may be shirred or tailored or pleated in appearance, for example. The interior 28 of the cap 14 may also be fitted with a keepsake frame, or with decorative piping.

The lower shell 12 of the casket 10 preferably includes standard ornamental hardware 32 which includes handles, either affixed directly to casket 10 or affixed using movable hardware that allows for a swinging action, such as a metal swing, for lifting the casket 10.

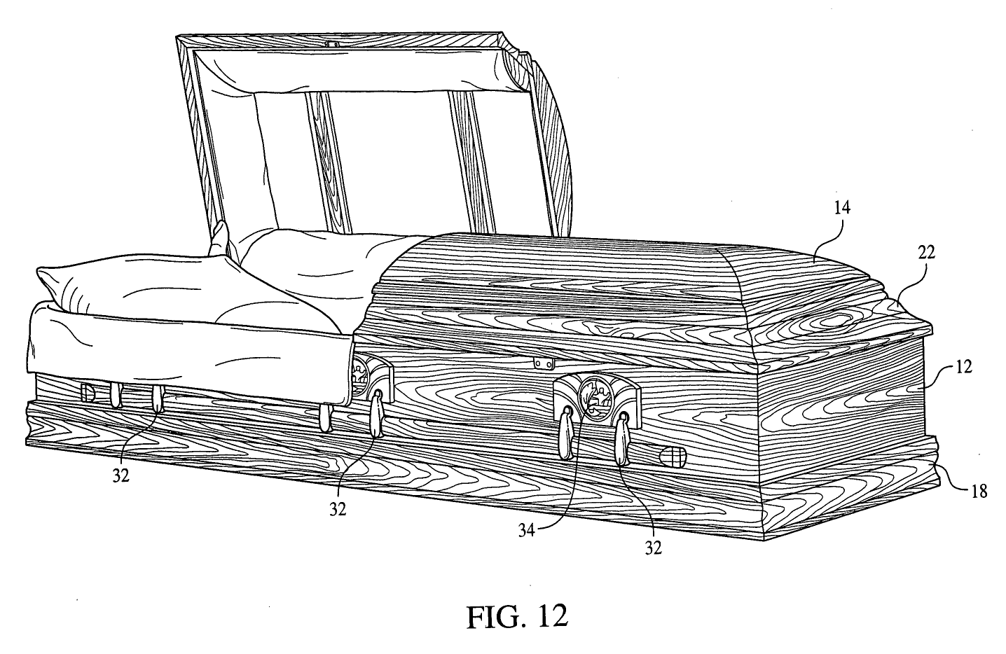

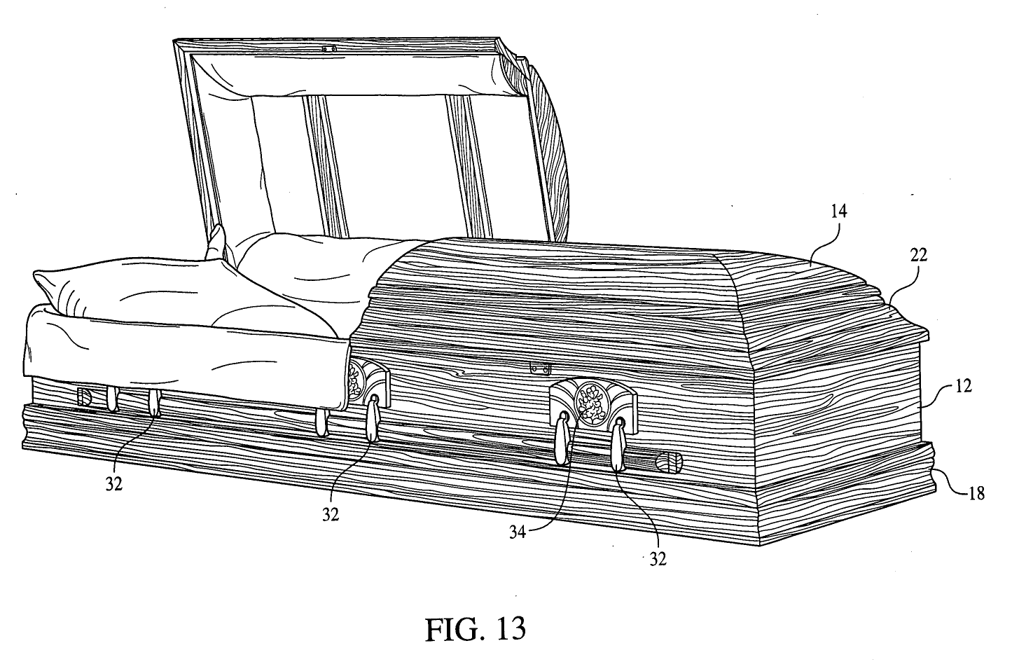

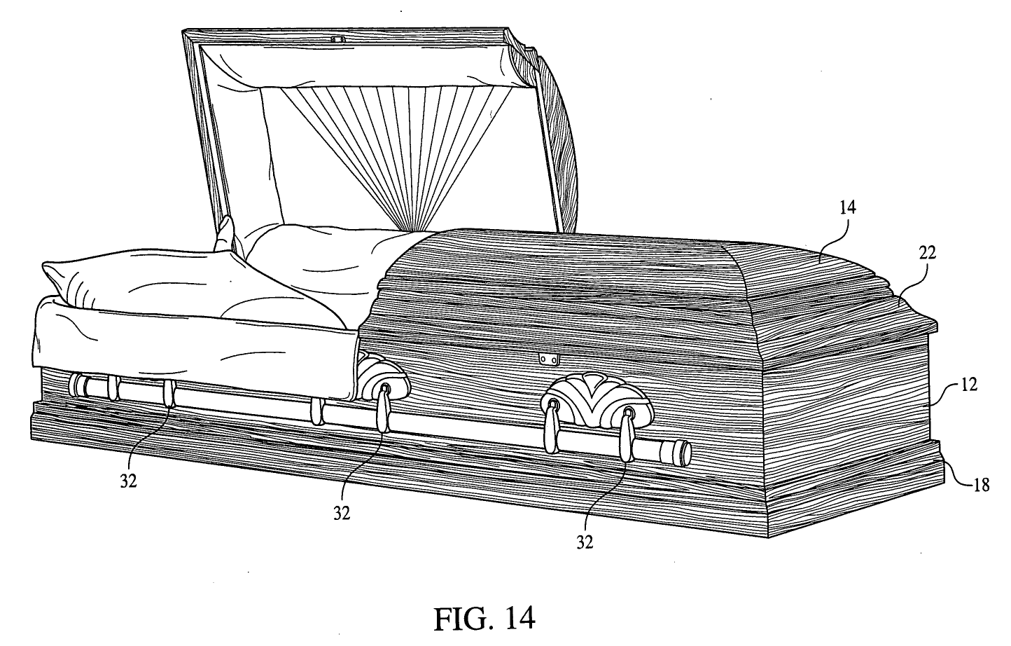

In an alternative embodiment of the present invention as illustrated in FIGS. 12-14, the cap 14 is rounded or domed. The base portion 18, the lower shell 12, the rim portion 22, and the cap 14 are all covered with a non-wood veneer. The non-wood veneer may have a wood like appearance such as oak (FIG. 12) or cherry (FIGS. 13 and 14). Examples of other non-wood veneer finishes are pine and mahogany or any other suitable wood veneers as well as painted metals, non-painted metals such as bronze, stainless, copper and stone tones such as marble, granite, sandstone and other logical variations of all the above. The casket may further have six (as illustrated) or eight handle attachments 32 with removable bronze keepsakes ornaments 34 which may be removed and given to a family member to keep as a memento (FIGS. 12 and 13).

The non-wood veneer covered caskets are preferably formed from medium density fiber (MDF) board. MDF is a type of hardboard, which is made from wood fibers glued under heat and pressure. The domed cap is preferably formed from 6 boards of MDF board. The boards are attached together using a tongue and groove connection and have a machined radius to form the curve of the cap. This manufacturing process results in a domed cap having a smooth surface which allows the application of a non-wood veneer by an adhesive.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims.

1. A casket comprising:
a lower shell having a body portion and a base portion surrounding the body portion; and
a cap attached to the lower shell and having a lid portion and a rim portion surrounding the lid portion; wherein the base portion of the lower shell and the rim portion of the cap are covered in a veneer and the body portion of the lower shell and the lid portion of the cap are covered in cloth or leather.

2. The casket of claim 1, wherein the veneer is a wood veneer.

3. The casket of claim 1, wherein the veneer is a man-made veneer.

4. A casket comprising:
a lower shell; and
a domed cap attached to the lower shell;
wherein the lower shell and the domed cap are covered in a non-wood veneer.

5. The casket of claim 4, further comprising at least one removable ornament on the lower shell.
